(19) United States
(12) Patent Application Publication
(10) Pub. No.: US 2011/0026248 A1
(43) Pub. Date: Feb. 3, 2011

(54) MULTI-LAYER LIGHTING UNIT WITH IMPROVED PROPERTIES AND ITS USE

(75) Inventors: Gunther Stollwerck, Krefeld (DE); Klaus Meyer, Dormagen (DE); Andreas Lyding, Duisburg (DE); Heinz Pudleiner, Krefeld (DE); Günther Walze, Taipei (TW)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/847,217

(22) Filed: Jul. 30, 2010

(30) Foreign Application Priority Data
Aug. 1, 2009 (EP) 09009955.7

(51) Int. Cl. F21V 13/10

(52) U.S. Cl. 362/235

(57) ABSTRACT

A lighting unit includes a reflector, two or more light sources, and at least one diffuser plate. The light sources have a gap of at least ≧30 mm from each other, and the gap between the light sources and the diffuser plate is ≦25 mm. The diffuser plate comprises a lenticular plate. An advanced compound parabolic concentrator scatter film is arranged on the lenticular plate, and a further scatter film is arranged on the advanced compound parabolic concentrator scatter film.

### BACKGROUND OF THE INVENTION

1. Priority

Priority is claimed under 35 U.S.C. §119 to German Patent Application No. 09009955.7, filed Aug. 1, 2009. The aforementioned priority document is incorporated herein by reference in its entirety.

2. Field of the Invention

The field of the present invention relates to multi-layer lighting units.

3. Background

Multi-layer composite film materials, in particular multi-layer optical films, are becoming increasingly important because of numerous commercial applications. One application field is that of liquid crystal screens. These contain essentially two components, the so-called backlight unit in which the light is generated and modified by various optical layers, and the LCD (liquid crystal display). This contains red, green and blue colour filters and liquid crystals, which are activated alternately by fine current pulses and allow the light to pass.

Basically, a backlight unit (BLU) with direct backlighting (direct light system) of an LCD is constructed according to the following description. It usually consists of a housing, in which, depending on the size of the backlight unit, a different number of fluorescent tubes, so-called CCFLs (cold cathode fluorescent lamps), are arranged. The fluorescent tubes are usually arranged parallel to each other. Using other light sources, e.g. LEDs, is also known, but this does not otherwise affect the construction of the BLU in principle. The inside of the housing is equipped with a surface which reflects white diffuse light. A diffuser plate, which can be 1 to 3 mm thick, preferably 1.1 to 2 mm thick, rests on this lighting system. On the diffuser plate is a set of plastic films, which optimise the light yield. The diffuser film, like the diffuser plate, scatters the light evenly, so that the stripe pattern of the fluorescent tubes is blurred and the most homogeneous possible lighting can be achieved. This is followed by a prism film (brightness enhancing film [BEF]). Its surface is structured so that incident light from different directions is aligned directly forwards in the direction of the LCD. On the prism film, there is usually a further optical film, the so-called dual brightness enhancing film (DBEF). The DBEF lets through only exactly linearly polarised light, which can be exploited by the crystals in the LCD. Differently aligned light is reflected back at the DBEF to the reflecting surface of the inside of the housing, and then reflected forwards again in the direction of the DBEF. In this way the DBEF increases the yield of correctly polarised light, and thus the efficiency of the whole BLU. The linearly polarising film is directly under the LC display above it.

If this traditional construction is used, one problem is that in particular in the case of a specially great gap between the fluorescent tubes and a small gap between the fluorescent tubes on the one hand and the diffuser plate above them on the other, sufficient homogenisation of the light can no longer be achieved. The light sources are then discernable to the human eye on the LCD. The possible homogenisation of the light distribution, that is the ability of the lighting units to hide the light sources and their arrangement to some extent, is also called “hiding power”.

From U.S. Pat. No. 5,592,332, lenticular plates to homogenise light distribution are known. The arrangement of crossed lenticular plates is also disclosed, but their function is not described in more detail.

From WO 2007/094426A1, arrangements with crossed lenticular plates, which are arranged above a densely packed LED array, are known. The gap between LEDs and scatter plate is not described in it.

From patent application WO 2008/047794, lighting constructions with crossed lenticular films, which are used in a backlight unit with a gap of 24 mm between the fluorescent tubes, are known.

From DE 10 2007 033300, scatter films and plates with light-directing structures consisting of a lens area and a compound parabolic concentrator (CPC) area, and the use of them as diffuser plates in a backlight unit, are known. Here gaps between the lamps and gaps between lamps and scatter plate are given.

The application field of flat screens makes high demands on the processability and other properties of the optical films which are used there. If diffuser plates are used in the so-called backlight units of flat screens, what matters in particular is very high and homogeneous light density of the whole system, so that the picture of the flat screen is as bright as possible.

It is therefore desirable to provide a lighting unit with which improved homogenisation of the light distribution can be achieved. The lighting units disclosed herein are intended to be suitable for sophisticated backlight unit constructions and LCD flat screens, and to have sufficiently high homogeneity of light distribution. The intention is that it should be possible to distribute the light by means of the lighting unit so homogeneously that the light sources which are used in the lighting unit are no longer discernable to the human eye.

### SUMMARY OF THE INVENTION

The present invention is directed toward a multi-layer lighting unit including a reflector, two or more light sources, and at least one diffuser plate. The light sources have a gap of ≧30 mm from each other, and the gap between the light sources and the diffuser plate is ≦25 mm. The diffuser plate is a lenticular plate, with a first advanced compound parabolic concentrator (ACPC) scatter film arranged on the lenticular plate, and with a further scatter film arranged on the first ACPC scatter film.

Several different options may be incorporated into this basic structure, either individually or in combination. For example, traditional fluorescent tubes can be used as light sources. Alternatively, other light sources such as LEDs can be used. As an option, the structure of the ACPC scatter film may be arranged at approximately 90° to the linear structure of the lenticular plate. As another option, between the first ACPC scatter film and the further scatter film, a second ACPC scatter film may be arranged. The structure of this second ACPC scatter film may be arranged at approximately 90° to the structure of the first ACPC scatter film. As yet another option, a hemispherical surface structure, a prism film and/or a polarisation film may be arranged on the further scatter film.

Accordingly, an improved multi-layer lighting unit is disclosed. Advantages of the improvements will appear from the drawings and the following description.

### BRIEF DESCRIPTION OF THE DRAWINGS

In the drawings, wherein like reference numerals refer to similar components:

FIG. 1 shows schematically a diagonal plan view of a first embodiment of a multi-layer lighting unit;

FIG. 1A shows a depiction of the brightness variation of the lighting unit from FIG. 1,

FIG. 2 shows schematically a diagonal plan view of a second embodiment of a multi-layer lighting unit including a scatter film with a hemispherical surface structure,

FIG. 3 shows schematically a diagonal plan view of a first alternative multi-layer lighting unit for comparison purposes, the lighting unit including a traditional diffuser plate scatter film set with a standard diffuser plate and three scatter films;

FIG. 3a shows the brightness distribution which is achieved with the lighting unit from FIG. 3,

FIG. 4 shows schematically a diagonal plan view of a second alternative multi-layer lighting unit for comparison purposes, the lighting unit including a traditional diffuser plate scatter film set with a standard diffuser plate and two droplet films;

FIG. 5 shows schematically a diagonal plan view of a third alternative multi-layer lighting unit for comparison purposes, the lighting unit including a diffuser plate scatter film set with a lenticular diffuser plate and two droplet films;

FIG. 6 shows schematically a diagonal plan view of a fourth alternative lighting unit for comparison purposes, the lighting unit including a traditional diffuser plate scatter film set with a standard diffuser plate with a prism film; and

FIG. 7 shows schematically a diagonal plan view of a lighting unit from the prior art for comparison purposes, the lighting unit including a traditional diffuser plate scatter film set with a lenticular diffuser plate with a prism film.

For clarity, the individual plates and films of the depicted lighting units are shown in a somewhat exploded representation.

### DETAILED DESCRIPTION OF THE PREFERRED EMBODIMENTS

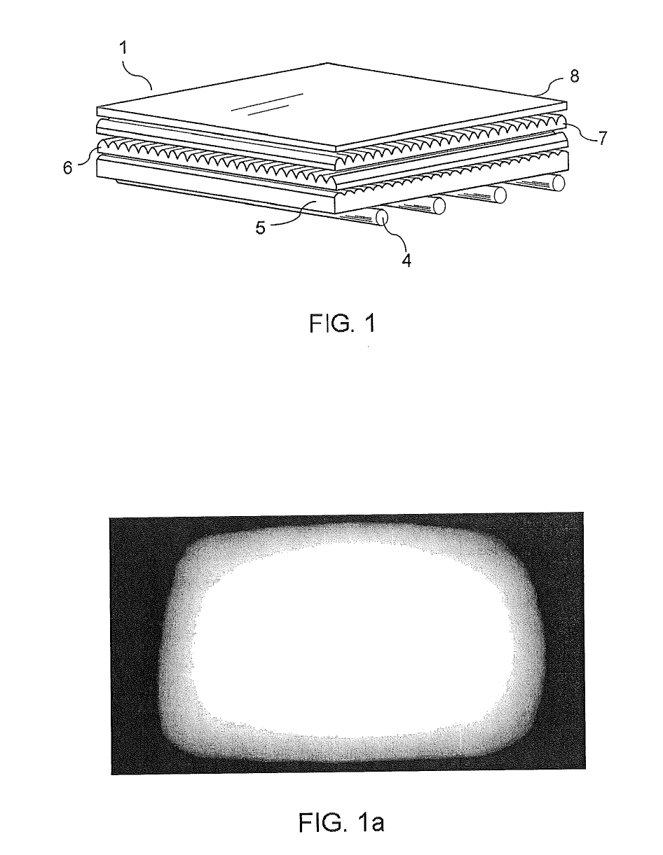

FIG. 1 shows a diagonal plan view of a lighting unit 1, with two ACPC scatter films, the reflector not being shown. The diffuser plate 5 is a lenticular plate, the linear structure of the lenticular plate 5 preferably being oriented along, i.e. parallel to, the fluorescent tubes 4. On this lenticular plate 5, a scatter film 6 with an ACPC structure is placed. The linear structure of the ACPC scatter film 6 is preferably oriented transversely to the alignment of the fluorescent tubes 4. On this ACPC scatter film 6, a further ACPC scatter film 7 is arranged, its linear structure preferably being oriented along the fluorescent tubes 4. As a third, further scatter film 8, for example an upper diffuser, Makrofol TP 293 1-4 of Bayer MaterialScience, is placed. Even with a gap between the fluorescent tubes 4 of ≧40 mm and a gap between the fluorescent tubes 4 and the diffuser plate 5 of ≦21 mm, with this preferred construction of the lighting unit outstanding homogenisation of the light distribution can be achieved, so that the individual fluorescent tubes 4 do not appear discernable to the human eye.

FIG. 1A shows a depiction of the brightness variation of the lighting unit from FIG. 1. The brightness variation was measured with a CCD camera of the STARLIGHT XPRESS Ltd. company, model SXVF-H9. The achieved homogenisation of the light distribution is so good that the individual light sources are not discernable to the human eye.

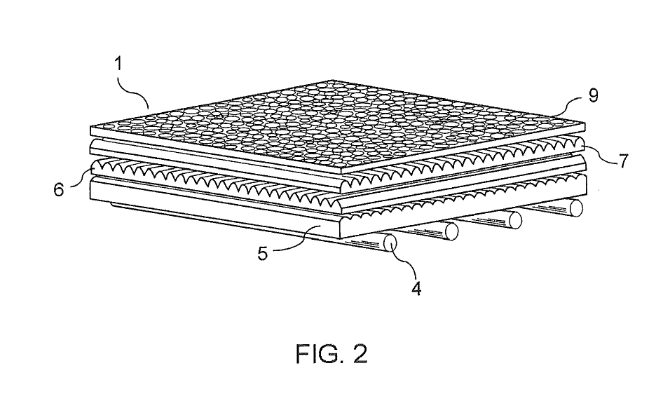

FIG. 2 shows a diagonal plan view of an alternative embodiment of the lighting unit 1, with two ACPC scatter films 6, 7, the reflector not being shown. The diffuser plate 5 is a lenticular plate, the linear structure of the lenticular plate 5 preferably being oriented along, i.e. parallel to, the fluorescent tubes 4. On this lenticular plate 5, a scatter film 6 with an ACPC structure is placed. The linear structure of the ACPC scatter film 6 is preferably oriented transversely to the alignment of the fluorescent tubes 4. On this ACPC scatter film 6, a further ACPC scatter film 7 is arranged, its linear structure preferably being oriented along the fluorescent tubes 4. As a third, further scatter film 9, a scatter film with a hemispherical structure, for example UTE 2 of the Mirae Nano Technology company, Korea, is placed. Even with a gap between the fluorescent tubes 4 of ≧40 mm and a gap between the fluorescent tubes 4 and the diffuser plate 5 of ≦21 mm, with this preferred version of the lighting unit 1 outstanding homogenisation of the light distribution can be achieved, so that the individual fluorescent tubes 4 do not appear discernable to the human eye.

The diffuser plate, a lenticular plate with light-directing surface structures, can be a diffuser plate produced with an advanced compound parabolic concentrator structure. Production of such structures and use of them on diffuser plates is disclosed in DE 10 2007 033 300 A1, for example. The surface structures of scatter plates and scatter films are also called simply structures below.

Production of lenticular plates which are suitable for use as the diffuser plate is also disclosed in patent application US 2007/0126145 A1, for example. The lenticular plates which are used can for example have a thickness of ≧0.5 mm to ≦3.0 mm, in particular ≧1.2 mm.

In the same way, the scatter films can be provided with an ACPC structure. Basically, scatter films are merely made thinner than the similarly produced diffuser plates. Without this value being fixed, scatter plates are usually produced with a thickness of ≧1.2 mm, scatter films then having a thickness of ≦1.2 mm. Preferably, one or two scatter films with ACPC structure can be arranged on the lenticular plate. Lighting units with more than two scatter films with ACPC structure are also conceivable.

As scatter films, which are arranged on the ACPC scatter film, there can be, in particular, scatter films with hemispherical surface structure. Such scatter films with hemispherical surface structure are disclosed, for example, in patent application US 2006/0239008 A1. Said pictorially, the surface structure of such films is in the form of multiple elevations on a substrate, having approximately the shape of droplets arranged next to each other, and is therefore also called a droplet-like structure. Such scatter films are also called droplet films. The scatter films with droplet-like structure can for example have a thickness of ≧50 μm and ≦500 μm, preferably ≧100 μm and ≦400 μm. Here “thickness” of the film is understood as the maximum thickness, taking account of the elevations.

Other scatter films which can be used instead of the droplet film include scatter films with scatter additives, scatter films with a statistical scatter surface or combinations of them.

With the above-mentioned components a lighting construction with a special combination and arrangement of structured scatter plates and films is provided on the diffuser plate (a lenticular plate), and even in the case of a sophisticated construction with large gaps between the light sources and a specially small gap between the light sources and the diffuser plate, it makes specially good homogenisation of the light distribution possible. With such lighting units, advantageously, homogeneous light distribution with brightness fluctuations of ≦1% can be achieved. Also, the efficiency of the homogenisation of the light can even be so good that the brightness fluctuations, despite large gaps between the light sources and a specially advantageous flat construction of the whole lighting unit because of the small gap between the diffuser plates and the light sources, are not discernable to the human eye.

It is possible, but less preferred, that between the light sources and the lenticular plate as diffuser plate a further diffuser plate and/or diffuser film is arranged. This additional diffuser plate can, for example, be a traditional diffuser plate of transparent plastic with scatter particles. Light-scattering plastic compositions, which can be used for diffuser plates and diffuser films in flat screens, are described, for example, in WO 2007/039130 A1 and WO 2007/039131 A1. However, it is also possible, at this position between the light sources and the lenticular plate, i.e. the diffuser plate, in the lighting unit, to use a diffuser plate and/or diffuser film with light-directing surface structures.

The gap between the light sources, in particular fluorescent tubes, can be chosen to be ≧40 mm and even ≧50 mm. Advantageously, in this way large lighting units can be produced less expensively, since in total fewer light sources must be used with sufficient homogenisation and brightness. Sufficient homogenisation of the light distribution is understood as meaning that the individual light sources can no longer be discerned by the human eye.

The gap between the light sources and the diffuser plate arranged above them can be ≦21 mm, ≦15 mm and even ≦10 mm. Surprisingly, it was found that with the combinations of structured scatter films, even specially flat constructions with sufficient homogenisation of the light distribution and sufficient brightness of the lighting unit can be obtained.

When fluorescent tubes are used as light sources, the lenticular plate has a linear structure, which is aligned parallel to the arrangement of the fluorescent tubes. The lenticular plate, which is used as a diffuser plate, has a corrugated linearly structured surface, the linear structure preferably consisting of tubular lenses arranged parallel to each other. For example, the linear structure can be an ACPC structure. In the lighting unit, the lenticular plate is directly above the light sources. Surprisingly, it has been shown that with this embodiment of the lighting unit, with the parallel alignment of the fluorescent tubes to the linear structure of the diffuser plate, its properties, in particular the optical quality and the possible homogenisation of the light distribution, can again be improved.

The structure of the advanced compound parabolic concentrator scatter film can be arranged at least approximately at an angle of 90° to the linear structure of the lenticular plate. Preferably, the orientation of the scatter film structures is thus chosen so that they are formed essentially perpendicularly to each other. In this way the efficiency of the homogenisation can be further improved.

In another version of the lighting unit, between the first advanced compound parabolic concentrator scatter film and the further scatter film, in particular with hemispherical surface structure, at least one second advanced compound parabolic concentrator scatter film can be arranged. With this combination of structured scatter films within the lighting unit, sufficient homogenisation of the light distribution can be achieved even for specially sophisticated lighting constructions, e.g. for use in flat screens. The quality of the lighting unit can thus be improved again.

The structure of the second ACPC scatter film 7 can be aligned at least approximately at an angle of 90°, i.e. essentially perpendicular to the structure of the first ACPC scatter film 6. In this way the achieved homogenisation effect can be increased still more. The homogenisation effect is specially good if the structure of the first scatter film is again arranged at least approximately at an angle of 90° to the structure of the lenticular plate.

On the further scatter film, which rests on the ACPC scatter film and in particular has a hemispherical surface structure, a prism film and/or a polarisation film can be arranged.

As the prism film, any film which by its structured surface can align incident light from different directions into a specified direction can be used. Preferably, this prism film can be suitable as so-called brightness enhancing film (BEF) in LCDs.

As the polarisation film, any optical film which lets through only exactly linearly polarised light can be used. This optical film is also used and designated in backlight units as so-called dual brightness enhancing film (DBEF). Reflecting polarisers (DBEF) are known in the prior art. For example, in WO 1996/19347 multi-layer optical films are described as reflecting polarisers. Differently aligned light is reflected back at the DBEF to the reflector, and then reflected forwards again in the direction of the DBEF. In this way the DBEF increases the yield of correctly polarised light, and thus the efficiency of the whole lighting unit. Advantageously, in liquid crystal screens the DBEF lets through only light which can be exploited by the crystals in the LCD. The linearly polarising film is directly under the LC display above it.

These additionally provided films, the prism film and polariser film, can be used in the construction of the lighting unit alternatively or in combination with each other, and increase the efficiency of the lighting unit.

The multi-layer lighting unit as described above can be used specially advantageously as a backlight unit for flat screens, for example. One or more of the preferred versions of the lighting unit described above can be used as required, alternatively or in combination with each other. Such sophisticated backlight units have, as well as good optical properties, specially good quality and optical performance. In particular, the homogenisation of the light distribution is a primary task of the diffuser plate and the diffuser film set.

The multi-layer lighting unit may also be advantageously used in screens, in particular liquid crystal screens. A further subject is therefore also a screen, in particular a liquid crystal screen, containing multi-layer a lighting unit. Advantageously, the lighting units and backlight units are suitable for specially sophisticated and therefore also specially flat screen constructions. Advantageously, the light source gaps can be chosen to be specially large, in which case good brightness of the system and good homogenisation of the light distribution can be achieved. The screens are therefore simple in construction and inexpensive to produce, and of good optical quality.

In summary, multi-layer lighting units, which have improved homogenisation of the brightness distribution over the light sources, in particular fluorescent tubes, which are used in them, said lighting units being specially suitable for use in sophisticated backlight units and use in liquid crystal flat screens, are disclosed. The lighting units include a sequence of a lenticular plate, the ACPC scatter films placed on it and the scatter film which is in turn arranged on it. Advantageously, with lighting units and the special combinations of scatter films which are used in them, even with large gaps between the light sources combined with a small gap between the light sources and the diffuser plate, specially homogeneous light distribution with brightness fluctuations of ≦1% can be achieved.

The following examples are provided without intent to limit the scope of the invention:

### Example 1

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. As the diffuser plate, a lenticular diffuser plate LQ 1200 of Bayer Sheet Korea, with a thickness of 1.2 mm, is used. The linear structure of the lenticular plate is oriented along the CCFLs. On this lenticular plate, a scatter film with an ACPC structure with the following parameters is placed: acceptance angle: 40°, shortening factor: 0.1, polymer: polycarbonate, polynomial domain: 2nd order polynomial. The linear structure of the ACPC scatter film is oriented transversely (vertically) to the CCFLs. On this, a further, identical ACPC scatter film is placed, its linear structure being oriented along (parallel to) the CCFLs. As the third scatter film, a scatter film (upper diffuser, Makrofol TP 293 1-4 of Bayer MaterialScience AG), with a thickness of 220 μm, is used. The construction of this lighting unit is shown in FIG. 1. The brightness variation over the lamps was 0.2% and is thus not discernable to the human eye. The brightness variation was measured with a CCD camera of the STARLIGHT XPRESS Ltd. company, model SXVF-H9, and is shown in FIG. 1a.

### Example 2

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. As the diffuser plate, a lenticular diffuser plate LQ 1200 of Bayer Sheet Korea, with a thickness of 1.2 mm, is used. The linear structure of the lenticular plate is oriented along the CCFLs. On this lenticular plate, a scatter film with an ACPC structure with the following parameters is placed: acceptance angle: 40°, shortening factor: 0.1, polymer: polycarbonate, polynomial domain: 2nd order polynomial. The linear structure of the ACPC scatter film is oriented transversely (vertically) to the CCFLs. On this, a further, identical ACPC scatter film is placed, its linear structure being oriented along (parallel to) the CCFLs. As the third scatter film, a scatter film with a hemispherical structure (UTE 2 of the Mirae Nano Technology company from Korea) is placed. The construction of this lighting unit is shown in FIG. 2. The brightness variation over the lamps was 0.2% and is thus not discernable to the human eye. The brightness variation was measured with a CCD camera of the STARLIGHT XPRESS Ltd. company, model SXVF-H9.

The following examples are provided to highlight advantages of the disclosed invention, without intent to limit the scope of the invention:

### Comparison Example 1

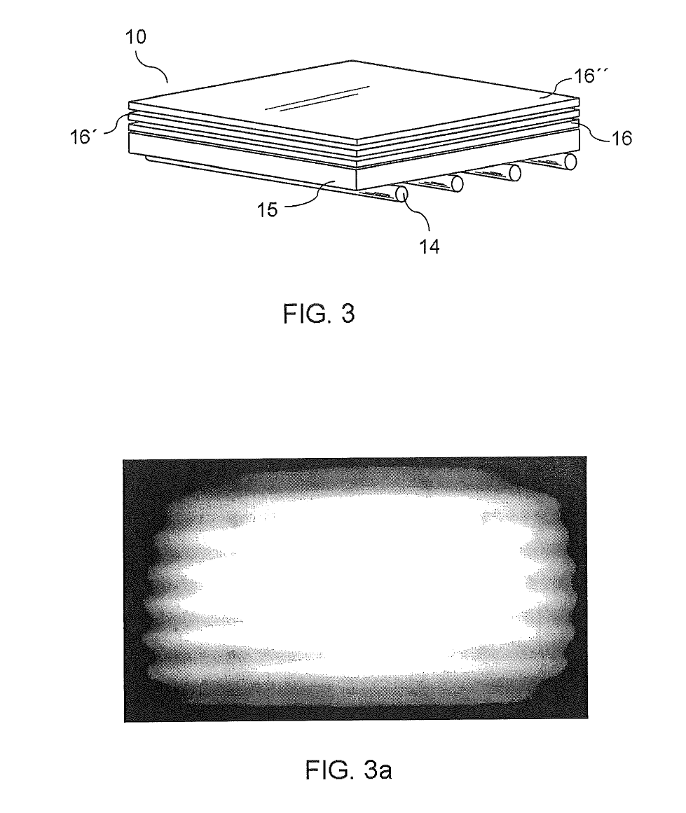

FIG. 3 shows a diagonal plan view of a lighting unit 10, for comparison purposes, with a traditional, not structured diffuser plate 15 and three traditional scatter films 16, 16′ and 16″ with scatter particles placed on it, the reflector not being shown. The brightness variation over the fluorescent tubes 14 was clearly worse than the lighting units of Examples 1 and 2 described above, since in this case the individual fluorescent tubes are discernable to the human eye.

FIG. 3a shows a depiction of the brightness variation of the lighting unit from FIG. 3. The brightness variation was measured with a CCD camera of the STARLIGHT XPRESS Ltd. company, model SXVF-H9, and as described above is clearly worse than that of the lighting units of Examples 1 and 2.

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. In this case a standard diffuser plate and film set were used: as the diffuser plate, a standard diffuser plate DQ 1200 of Bayer Sheet Korea, with a thickness of 1.2 mm, was used. On this diffuser plate, three equal lower diffuser films, Kimoto GM 18803, were placed. The construction of this lighting unit is shown in FIG. 3. The brightness variation over the lamps was >1% and was thus very easily discernable to the human eye. The brightness variation was measured with a CCD camera of the STARLIGHT XPRESS Ltd. company, model SXVF-H9, and is shown in FIG. 3a.

### Comparison Example 2

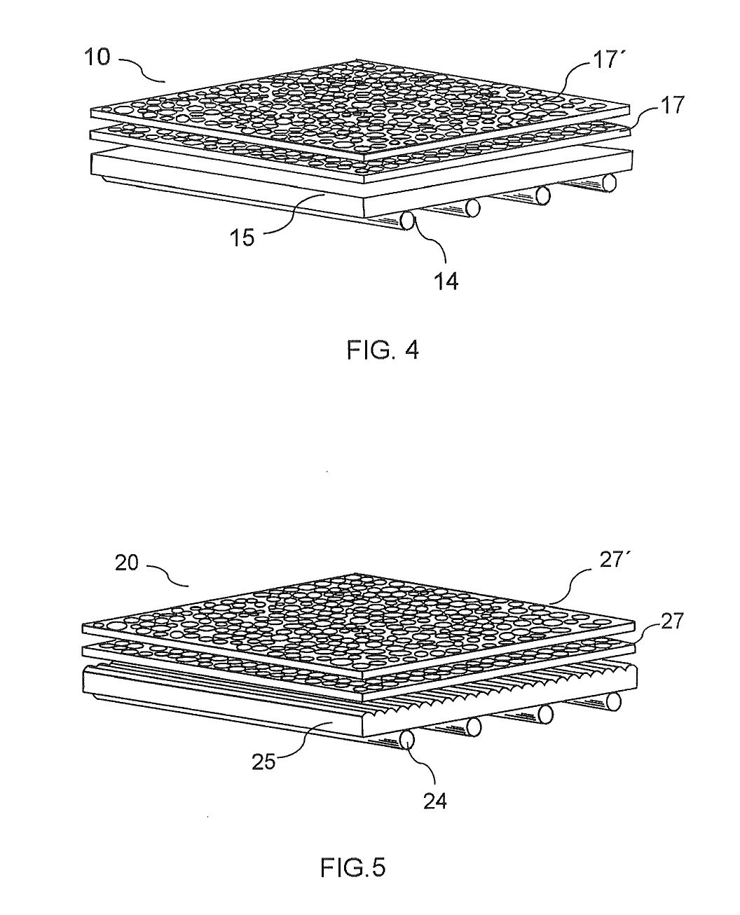

FIG. 4 shows a diagonal plan view of a lighting unit 10, for comparison purposes, with a traditional, not structured diffuser plate 15 and two scatter films 17 and 17′ with hemispherical surface structure placed on it, the reflector not being shown. In the case of this lighting unit, the brightness variation over the lamps 14 was discernable to the human eye, and thus worse than in the case of the lighting units of Examples 1 and 2 described above.

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. A standard diffuser plate and film set were used: as the diffuser plate, a standard diffuser plate DQ 1200 of Bayer Sheet Korea, with a thickness of 1.2 mm, was used. On this diffuser plate, two commercially available scatter films with hemispherical structure, UTE 2 of the Mirae Nano Technology company from Korea, were placed. The construction of this lighting unit is shown in FIG. 4. The brightness variation over the lamps was >1% and is thus very easily discernable to the human eye. The brightness variation was measured with a CCD camera of the STARLIGHT XPRESS Ltd. company, model SXVF-H9.

### Comparison Example 3

FIG. 5 shows a diagonal plan view of a lighting unit 20, for comparison purposes, with a lenticular plate being arranged on the light sources 24 as a diffuser plate 25. On the lenticular plate 25, two scatter films 27 and 27′ with hemispherical surface structure are placed. The reflector is not shown. In the case of this construction of the lighting unit, the brightness variation over the fluorescent tubes 24 was discernable to the human eye, and thus worse than the lighting units of Examples 1 and 2.

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. A standard diffuser plate and film set were used: as the diffuser plate, a lenticular diffuser plate LQ 1200 of Bayer Sheet Korea, with a thickness of 1.2 mm, was used. The linear structure of the lenticular plate is oriented along the CCFLs. On this diffuser plate, two commercially available scatter films with hemispherical structure (UTE 2 of the Mirae Nano Technology company from Korea) are placed. The construction of this lighting unit is shown in FIG. 5. The brightness variation over the lamps was >1% and is thus very easily discernable to the human eye. The brightness variation was measured with a CCD camera of the STARLIGHT XPRESS Ltd. company, model SXVF-H9.

### Comparison Example 4

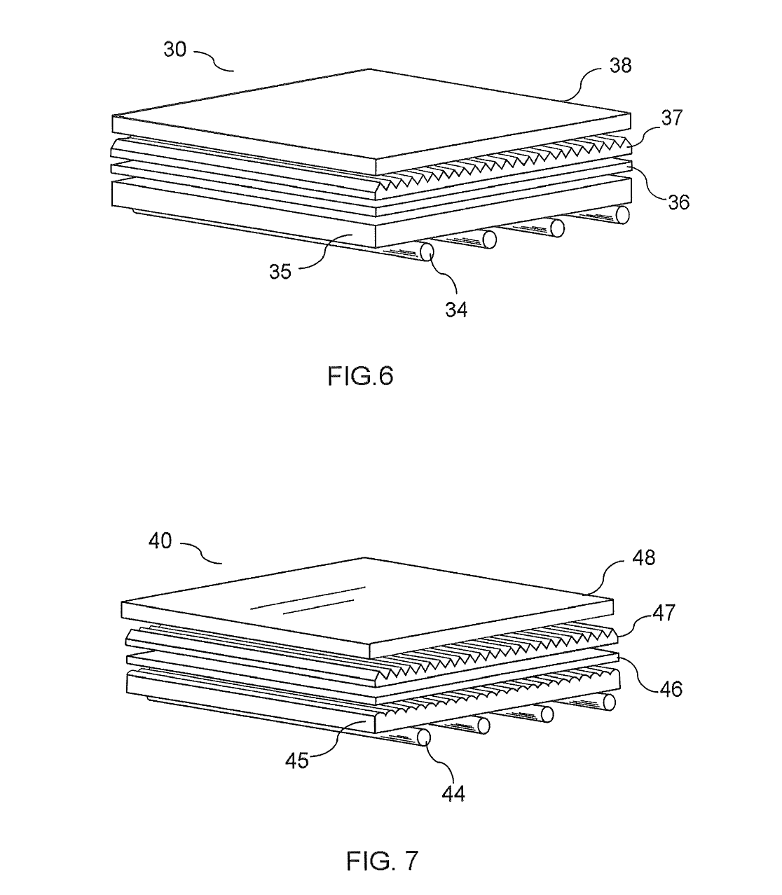

FIG. 6 shows a diagonal plan view of a lighting unit 30, for comparison purposes, with a traditional, not structured diffuser plate 35. On this diffuser plate 35, which is arranged above the light sources 34, a diffuser film 36, a prism film (BEF) 37, and on it a Dual Brightness Enhancement Film (DBEF) 38 are placed, the linear structure of the prism film 37 being aligned along and thus essentially parallel to the fluorescent tubes. The reflector is also not shown in this figure. In this case the brightness variation over the lamps 34 was discernable to the human eye, and thus worse than in the case of the lighting units of Examples 1 and 2 described above.

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. A standard diffuser plate and film set were used: as the diffuser plate, a standard diffuser plate DQ 1200 of Bayer Sheet Korea, with a thickness of 1.2 mm, was used. On this diffuser plate, a lower diffuser film, e.g. Kimoto 188 GM3, on that a commercially available prism film Vikuiti® Brightness Enhancement Film (BEF) II of the 3M company, and on that a commercially available Vikuiti® Dual Brightness Enhancement Film (DBEF) D 400 of the 3M company were placed. The linear structure of the prism film is oriented along the CCFLs. The construction of this lighting unit is shown in FIG. 6. The brightness variation over the lamps was >1% and is thus very easily discernable to the human eye. The brightness variation was measured with a CCD camera of the STARLIGHT XPRESS Ltd. company, model SXVF-H9.

### Comparison Example 5

FIG. 7 shows a diagonal plan view of a lighting unit 40, for comparison purposes, wherein on the light sources 44, a lenticular plate is arranged as a diffuser plate 45. The linear structure of the lenticular plate 45 is oriented along the CCFLs. On the lenticular plate 45, a diffuser film 46, a prism film (BEF) 47, and on it a Dual Brightness Enhancement Film (DBEF) 48 are placed. On this diffuser plate, a commercially available prism film, Vikuiti® Brightness Enhancement Film (BEF) II of the 3M company, and on it a commercially available Vikuiti® Dual Brightness Enhancement Film (DBEF) D 400 of the 3M company, were placed. The reflector is not shown. In the case of this construction of the lighting unit, the brightness variation over the lamps 44 was discernable to the human eye, and thus worse than the lighting units of Examples 1 and 2.

A lighting unit with a reflector and fluorescent tubes (CCFLs), with a gap between lamp centres of 50 mm, a lamp diameter of 3 mm and a gap between the fluorescent tubes and the diffuser plate of 21 mm, was submitted. A standard diffuser plate and film set were used: as the diffuser plate, a lenticular diffuser plate LQ 1200 of Bayer Sheet Korea, with a thickness of 1.2 mm, was used. The linear structure of the lenticular plate was oriented along the CCFLs. On this diffuser plate, a lower diffuser film, e.g. Kimoto 188GM3, a commercially available prism film Vikuiti® Brightness Enhancement Film (BEF) II of the 3M company, and on that a commercially available Vikuiti® Dual Brightness Enhancement Film (DBEF) D 400 of the 3M company were placed. The construction of this lighting unit is shown in FIG. 7. The linear structure of the prism film is oriented along the CCFLs. The brightness variation over the lamps was >1% and is thus very easily discernable to the human eye. The brightness variation was measured with a CCD camera of the STARLIGHT XPRESS Ltd. company, model SXVF-H9.

What is claimed is:

1. A multi-layer lighting unit comprising:
a reflector;
two or more light sources having a gap of at least ≧30 mm from each other;
at least one diffuser plate disposed on an opposite side of the light sources from the reflector, wherein the gap between the light sources and the diffuser plate is ≦25 mm, the diffuser plate comprising a lenticular plate;
a advanced compound parabolic concentrator scatter film arranged on the lenticular plate; and
a further scatter film arranged on the advanced compound parabolic concentrator scatter film.

2. The multi-layer lighting unit according to claim 1, wherein the light sources are fluorescent tubes, and the lenticular plate has a linear structure, which is aligned parallel to the fluorescent tubes.

3. The multi-layer lighting unit according to claim 1, wherein the structure of the advanced compound parabolic concentrator scatter film is arranged at approximately at an angle of 90° to the structure of the lenticular plate.

4. The multi-layer lighting unit according to claim 1, wherein a second advanced compound parabolic concentrator scatter film is arranged between the first advanced compound parabolic concentrator scatter film and the further scatter film.

5. The multi-layer lighting unit according to claim 4, wherein the structure of the second advanced compound parabolic concentrator scatter film is aligned at approximately at an angle of 90° to the structure of the first advanced compound parabolic concentrator scatter film.

6. The multi-layer lighting unit according to claim 1, wherein at least one of a prism film and a reflecting polarisation film are arranged on the further scatter film.

7. The multi-layer lighting unit according to claim 1, wherein the further scatter film is a scatter film with a hemispherical surface structure.
